(19) United States
(12) Patent Application Publication
(10) Pub. No.: US 2017/0207549 A1
(43) Pub. Date: Jul. 20, 2017

(54) DATA CONNECTOR

(71) Applicant: Spectra7 Microsystems, LTD., Palo Alto, CA (US)

(72) Inventors: Leo Chien Chang, Fremont, CA (US); Ebrahim Abunasrah, Little Rock, AR (US)

(21) Appl. No.: 15/411,558

(22) Filed: Jan. 20, 2017

Related U.S. Application Data
(60) Provisional application No. 62/281,059, filed on Jan. 20, 2016.

(51) Int. Cl. H01R 4/04; H01R 24/60

(52) U.S. Cl. CPC H01R 4/04; H01R 24/60; H01R 2107/00

(57) ABSTRACT

A differential data cable for high-speed signals includes a connector PCB with angled pads cable connection pads connected to a pair of differential data cable conductors, wherein the symmetrical angled configuration minimizes lead lengths, interface discontinuities, and common mode imbalance. A third pad may be connected to a return signal wire. The connector PCB may have a similar arrangement on the other side, and may have a ground plane in between. The cable may be placed over the ground plane and away from the edge. Pads may have a bump to shorten wire lengths. Wires are glued to the bumps using a UV-curable adhesive. Wires are positioned in an angle with the PCB.

### CROSS REFERENCES TO RELATED APPLICATIONS

This application claims priority from U.S. Provisional Patent Application Ser. No. 62/281,059, entitled “A Data Connector”, filed on Jan. 20, 2016, which is hereby incorporated by reference as if set forth in full in this application for all purposes.

### BACKGROUND

The present application relates in general to data communication systems, and more specifically to cables and connectors for transferring data between one system and another.

Data cables, their connectors, and connector form factors are often specified in industry standards related to specific data communication protocols. These industry standards usually take performance into account.

An aspect partially left to individual manufacturers is the final performance, provided that the minimums specified in an industry standard are met. The performance is impacted both by the raw cable and its connectors. Innovations, such as described in the present document, improve the quality of connectors without significant impact on their cost.

One example of a high-speed data cable is the quad small form-factor pluggable (QSFP) cable that supports hot-pluggable transceivers in 40 and 100 Gbits/second data communication systems. The data travels through four channels of nominally 10 or 25 Gbits/second each. The QSFP standard supports various communication protocols. QSFP connecters have 38 pins, including 4 high-speed transmit (TX) and 4 high-speed receive (RX) pairs. QSFP cables are often used in data centers, and to connect servers and switches. Embodiments of the invention are applicable to many industry standards for form factors that are used for high-speed data transmission. A few of those are small form-factor pluggable (SFP), QSFP, QSFP DD (double density), microQSFP, and miniature serial-attached small computer system interface high density (Mini-SAS HD).

### SUMMARY

Embodiments of the invention provide a connector printed circuit board (PCB) for high-speed signals carried in a differential data cable. The connector PCB comprises two high-speed cable connection pads on a first side. Two differential data cable conductors are electrically coupled to the high-speed cable connection pads. The connection pads are positioned in a symmetrically angled configuration to minimize differential data cable lead lengths and to minimize discontinuity for high-speed signals traveling between the differential data cable conductors and the high-speed cable connection pads. The connector PCB may further include a third pad positioned between the high-speed cable connection pads. A third differential data cable conductor electrically coupled to the third pad. The two high-speed cable connection pads are positioned symmetrically around the third pad.

The differential data cable may be a high-speed data twin-axial cable; the two differential data cable conductors may be signal wires; and the third differential data cable conductor may be a return signal wire, such as a drain wire or a twin-axial cable outer conductor. In some embodiments, the cable connection pads may be made with silver-plated copper.

The connector PCB may have a similar arrangement of pads and conductors (wires) on a second side. Embodiments may include a ground plane in between. The differential data cable may be placed over the ground plane and away from a connector PCB edge. Pads may include a bump to shorten wire lengths. Wires may be glued to the pads or bumps using a UV-curable adhesive. Cable conductors may be positioned in an angle with the connector PCB.

### BRIEF DESCRIPTION OF THE DRAWINGS

Various implementations will be described with reference to the drawings, in which:

FIG. 1 illustrates an example connector according to an embodiment of the invention;

FIG. 2 illustrates the geometry of connections between cable wires and a PCB according to one embodiment of the invention; and

FIG. 3 illustrates a cross-cut side view of connections between cable wires and a PCB according to an embodiment of the invention.

### DETAILED DESCRIPTION

Data cables, their connectors, and connector form factors are often specified in industry standards related to specific data communication protocols. These industry standards usually take performance into account. An aspect partially left to individual manufacturers is the final performance, provided that the minimums specified in an industry standard are met. The performance is impacted both by the raw cable and its connectors. Innovations, such as described in the present document, improve the quality of connectors without significant impact on their cost.

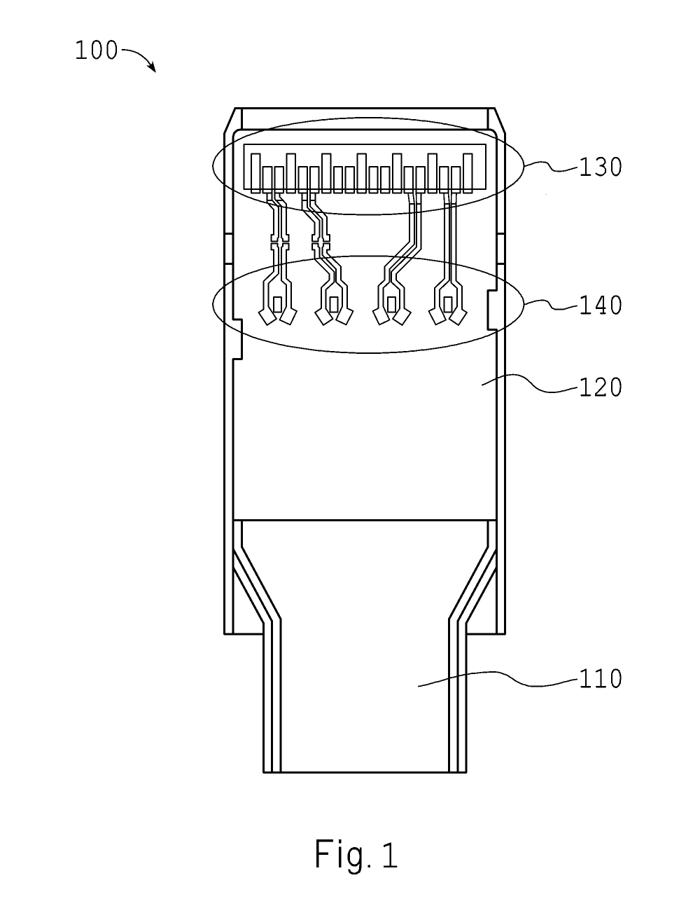

FIG. 1 illustrates an example connector 100 according to an embodiment of the invention. Example connector 100 includes metal bracket 110 and printed circuit board (PCB) 120. PCB 120 includes connector pads 130 and cable connection pads 140 (both are encircled). PCB tracks electrically couple connector pads 130 to cable connection pads 140. Metal bracket 110 holds PCB 120. Connector 100 conforms to the 28QSFP standard. It has 38 connector pads 130, 19 on each side of PCB 120. In normal use, connector 100 has another metal bracket (not shown), with the two brackets mounted to each other enveloping PCB 120 and an end of a raw cable (not shown) connected to the PCB as described herein. A raw cable may hold, for example, eight high-speed data twin-axial cables. In some embodiments, a single metal bracket may envelope PCB 120 and the cable end. In most embodiments, part of the bracket(s) and part of the cable end may be surrounded, held together, and protected by a plastic holder. FIG. 1 shows an example of how four of the eight high-speed data twin-axial cables may connect to PCB 120 on one side, whereas the other four of the eight high-speed data twin-axial cables may connect to PCB 120 on the other side. In various implementations, to minimize the cable's lead length (the length of a twin-axial cable's inner conductor that protrudes from the coaxial insulator), two high-speed cable connection pads 140 may be positioned in a symmetrically angled configuration. The angle may vary.

In some embodiments, the two high-speed cable connection pads 140 may surround a third cable connection pad 140 that connects a return signal wire to PCB 120's ground plane. The return signal wire may be a drain wire or outer conductor of the twin-axial cable pair. Distances between cable connection pads 140 may vary, depending on the embodiment. In some embodiments, connector pads 130, cable connection pads 140 and the PCB tracks may be made of silver-plated copper to improve connector 100's high-speed performance. Various embodiments minimize a discontinuity for high-speed signals traveling between the signal wires and cable connection pads 140 by using the angled configuration alone, the two high-speed cable connection pads 140 surrounding the third cable connection pad 140 alone, the cable connection pads 140 and the PCB tracks made of silver-plated copper alone, or any combination thereof.

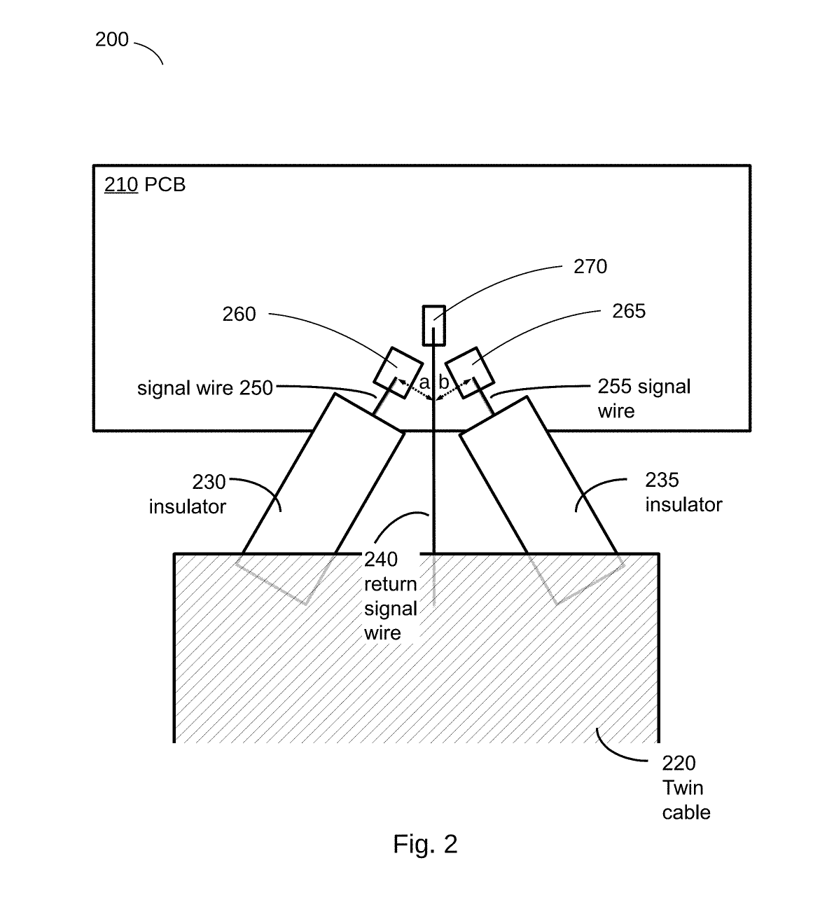

FIG. 2 illustrates the geometry 200 of connections between cable wires and a PCB according to one embodiment. The embodiment is suitable for transferring a differential pair of high-speed signals from a differential data cable via the PCB to a matching connector. FIG. 2 shows PCB 210, high-speed data twin-axial cable 220, coaxial insulator 230 around signal wire 250 and coaxial insulator 235 around signal wire 255, return signal wire 240, high-speed cable connection pads 260 and 265, and return signal wire connection pad 270. Whereas conventional connectors include parallel pads with the return signal wire connector on the outside, embodiments of the invention place high-speed cable connection pads symmetrically angled around a return signal wire connection pad. Embodiments keep cable connection pads short, to minimize bare wire length and coaxial insulator length.

The distances a and b in FIG. 2 between signal wire 250 and return signal wire 240, respectively signal wire 255 and return signal wire 240, are variable. They are equal (a=b), to implement the symmetry. In embodiments, the electrical field coupling of high-speed cable connection pad 260 (to which signal wire 250 is connected) to return signal wire connection pad 270 equals the electrical field coupling of high-speed cable connection pad 265 (to which signal wire 255 is coupled) to return signal wire connection pad 270. Equal coupling reduces common mode imbalance, which can suffer from any inadvertent common-mode-to-differential-mode conversion.

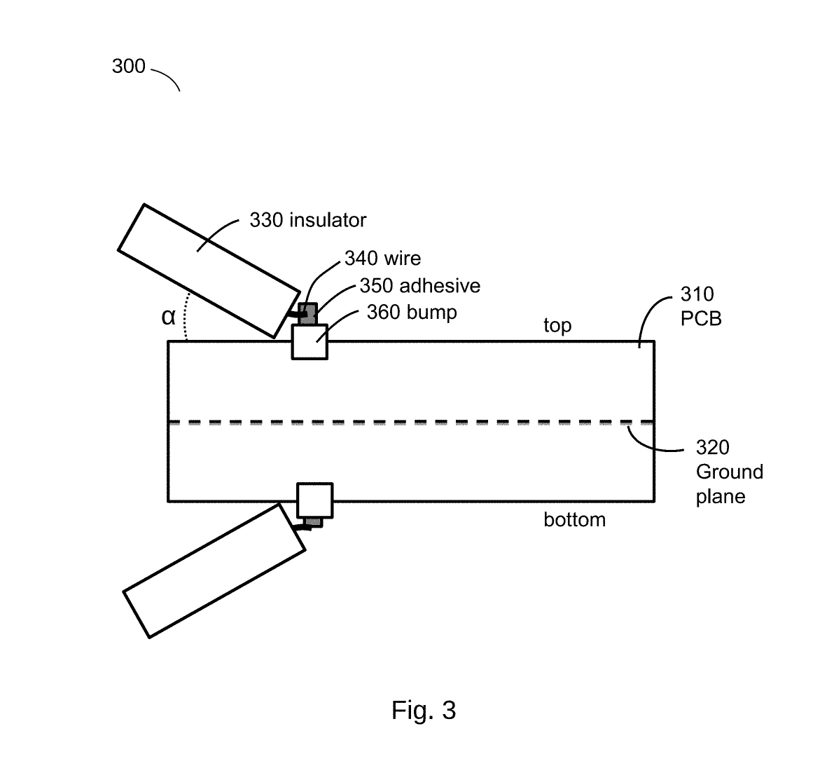

FIG. 3 illustrates a cross-cut side view 300 of connections between cable wires and a PCB 310 according to an embodiment of the invention. In prior-art cable-to-PCB connection arrangements, the cable wires are typically connected to pads situated at the edge of the PCB. A prior-art connector may include a notch in which the cable conductor's insulator may sink to allow for a short connection. In contrast, in embodiments of the present invention cables are positioned further from the edge of PCB 310, which has a ground plane 320 between its top and bottom to reduce crosstalk between cables on both sides. FIG. 3 further shows part of a first high-speed data twin-axial cable at the top, with coaxial insulator 330, and signal wire 340. A high-speed cable connection pad features bump 360, to which signal wire 340 is connected. A part of a second high-speed data twin-axial cable is shown at the bottom of PCB 310.

In embodiments of the present invention in which the cables are positioned further from the edge of the board, the signal wires are angled slightly (FIG. 3 shows angle α between coaxial insulator 330 and PCB 310, with the angle α in a plane orthogonal to the PCB 310 surface) and connected to the pads using UV-curable adhesive 350 to make the shortest connections to the pads. Embodiments of the invention may further include a bump 360 to allow the shortest connection.

Although the invention may be described with respect to specific types of cables and connectors (e.g., QSFP and differential data cables), it should be apparent that many other types of cables and connector designs can be used with features described and claimed herein. For example, embodiments of the invention are suitable for any connector that conforms with an industry standard for connector form factors used for high-speed data transmission. Although the description has been described with respect to particular embodiments thereof, these particular embodiments are merely illustrative, and not restrictive. Embodiments of the invention may single out, or combine, any of the techniques described herein. Use of the techniques described herein does not in any way prevent the simultaneous use of conventional best practices such as keeping PCB traces short.

It will be understood that the invention disclosed and defined in this specification extends to all alternative combinations of two or more of the individual features mentioned or evident from the text or drawings. These different combinations constitute various alternative aspects of the invention.

Although the description has been described with respect to particular embodiments thereof, these particular embodiments are merely illustrative, and not restrictive.

It will also be appreciated that one or more of the elements depicted in the drawings/figures can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A connector printed circuit board (PCB) for high-speed signals carried in a differential data cable, the connector PCB comprising:
a first high-speed cable connection pad on a first side of the connector PCB;
a second high-speed cable connection pad on the first side of the connector PCB;
a first differential data cable conductor electrically coupled to the first high-speed cable connection pad; and
a second differential data cable conductor electrically coupled to the second high-speed cable connection pad;
wherein the first and the second high-speed cable connection pads are positioned in a symmetrically angled configuration to minimize differential data cable lead lengths and to minimize discontinuity for high-speed signals traveling between the first and second differential data cable conductors and the first and second high-speed cable connection pads.

2. The connector PCB of claim 1, further comprising:
a third pad positioned between the first and the second high-speed cable connection pads on the first side of the connector PCB; and
a third differential data cable conductor electrically coupled to the third pad;
wherein the first and the second high-speed cable connection pads are positioned symmetrically around the third pad.

3. The connector PCB of claim 2, wherein: the differential data cable includes a high-speed data twin-axial cable; the first and second differential data cable conductors include first and second signal wires; and the third differential data cable conductor includes a return signal wire.

4. The connector PCB of claim 3, wherein the return signal wire includes a drain wire.

5. The connector PCB of claim 3, wherein the return signal wire includes an outer conductor of the high-speed data twin-axial cable.

6. The connector PCB of claim 1, wherein the first and the second high-speed cable connection pads include silver-plated copper.

7. The connector PCB of claim 2, further comprising:
a fourth high-speed cable connection pad on a second side of the connector PCB;
a fifth high-speed cable connection pad on the second side of the connector PCB;
a sixth pad positioned between the fourth and the fifth high-speed cable connection pads on the second side of the connector PCB;
a fourth differential data cable conductor electrically coupled to the fourth high-speed cable connection pad;
a fifth differential data cable conductor electrically coupled to the fifth high-speed cable connection pad; and
a sixth differential data cable conductor electrically coupled to the sixth pad;
wherein the fourth and the fifth high-speed cable connection pads are positioned symmetrically around the sixth pad and in an angled configuration to minimize differential data cable lead lengths and to minimize discontinuity for high-speed signals traveling between the fourth and fifth differential data cable conductors and the fourth and fifth high-speed cable connection pads.

8. The connector PCB of claim 7, further comprising a ground plane between the first side and the second side of the connector PCB.

9. The connector PCB of claim 3, wherein ends of the high-speed data twin-axial cable are placed over a ground plane and away from a connector PCB edge.

10. The connector PCB of claim 1, wherein the first and second high-speed cable connection pads each comprise a bump to further shorten differential data cable lead lengths.

11. The connector PCB of claim 1, wherein the first and second differential data cable conductors are mechanically coupled to the first and second high-speed cable connection pads using a UV-curable adhesive to further shorten differential data cable lead lengths.

12. The connector PCB of claim 1, wherein the first and second differential data cable conductors are positioned in an angle with the connector PCB to further shorten differential data cable lead lengths, wherein the angle is in a plane orthogonal to a connector PCB surface.

13. The connector PCB of claim 1, wherein the connector PCB conforms with an industry standard for connector form factors used for high-speed data transmission.
